(19) United States
(12) Patent Application Publication
(10) Pub. No.: US 2009/0037915 A1
(43) Pub. Date: Feb. 5, 2009

(54) Staging block-based transactions

(76) Inventors: Michael A. Rothman, Sammamish, WA (US); Vincent Zimmer, Federal Way, WA (US)

Correspondence Address: TROP PRUNER & HU, PC, 1616 S. VOSS ROAD, SUITE 750, HOUSTON, TX, 77057-2631, US

(21) Appl. No.: 11/888,156

(22) Filed: Jul. 31, 2007

(51) Int. Cl. G06F 9/312

(52) U.S. Cl. 718/101

(57) ABSTRACT

In one embodiment, the present invention includes a method for converting a write request from a file system transaction to a transaction record, forwarding the transaction record to a non-volatile storage for storage, where the transaction record has a different protocol than the file system transaction, and later forwarding it to the target storage. Other embodiments are described and claimed.

### BACKGROUND

In many computer systems, data is generated and then it is desired to store the data in a selected location, such as a mass storage device, e.g., a disk drive or other magnetic media. However, typically such mass storage devices operate slowly compared to the speed of processors and other silicon devices.

When generating a so-called write transaction to write data to such a storage, typically an outgoing file system transaction is generated, where the transaction is according to a protocol for the given storage device, which may be a local target such as a local disk drive of the computer system or a remote target such as a storage server, e.g., connected to the computer system by a network connection. To effect the transaction, typically an underlying application such as a word processing application will provide the data to an operating system (OS) file system driver, which in turn formats the data for the outgoing file system transaction. However, if this transaction is interrupted, e.g., due to an error, power failure or other such reason, data loss occurs and the transaction is unrecoverable/corrupted.

### BRIEF DESCRIPTION OF THE DRAWINGS

FIG. 1 is an example file system transaction in accordance with an embodiment of the present invention.

FIG. 2 is a structure of a non-volatile storage in accordance with an embodiment of the present invention.

FIG. 3 is a flow diagram of a method in accordance with one embodiment of the present invention.

FIG. 4 is a block diagram of a system in accordance with one embodiment of the present invention.

### DETAILED DESCRIPTION

In various embodiments, a platform-specific file system may be provided to enable caching of sector-based transactions in a desired location. That is, in various embodiments, rather than a file system dictated by the structure of given file system such as an OS-controlled file system, a platform may have a platform-specific file system enabled under control of, e.g., software such as software running on a virtual machine. Using such software mechanisms, transactions from an OS-based file system can be intercepted and provided to a desired location for storage as a transaction record. Then at a later time, the transaction record may be flushed (i.e., written) to a target location such as a mass storage device.

Thus in a platform having large amounts of fast non-volatile (e.g., flash) storage available, the platform and its associated firmware/software stack can be controlled such that it can cache sector-based transactions. Embodiments thus allow for these cached events to be converted into transactions (similar to a transactional filesystem). The exception here is that instead of a traditional transactional filesystem which has a specific format associated with a particular file system (e.g., an OS-based file system), a format that is platform-specific is provided to support a heterogeneous set of block-related targets, including local and remote (i.e., network-based) targets. In this way, replay of failed transactions or the continuation of transactions when a system might crash during the write process is enabled.

In various embodiments, all writes to a given non-volatile target are translated to a transaction-based format and posted to a local extremely fast (e.g., 600 megabytes per second (MB/s)) high density storage container. Later, the transactions are then flushed to the target. In this way, write-back cache speeds can be achieved with write-through operations (thanks to the high speed local solid-state silicon), yet in reality data is being translated and posted such that if a failure occurs due to system anomaly (e.g., crash/bug/etc.) when the system recovers, it can proceed to complete the transaction. Thus a generic mechanism can achieve such transacted file system capabilities regardless of the target storage device (local or remote).

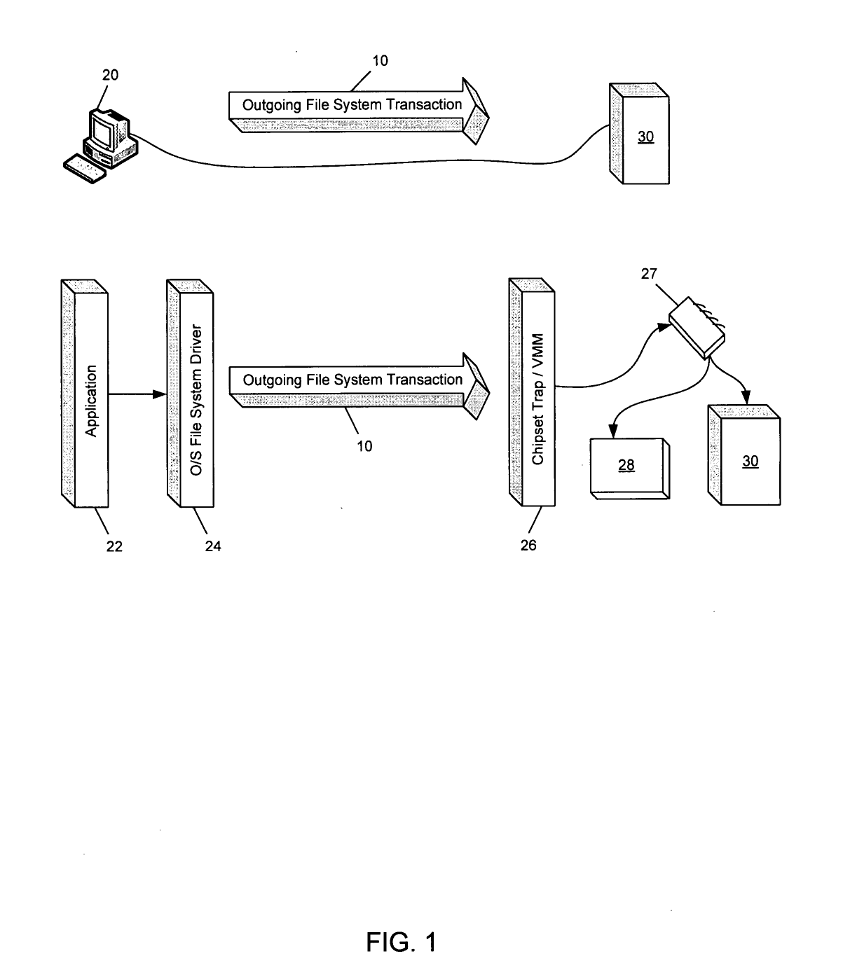

Referring now to FIG. 1, shown is an example file system transaction in accordance with an embodiment of the present invention. As shown in FIG. 1, an outgoing file system transaction 10 may be generated to enable data from a first system 20 to be stored on a second system 30, which may be a remote target. However, in various embodiments transactions may be provided to storage locations in many different locations, such as local storage targets as well as remote storage targets. To effect the transaction, an application 22 may provide data for storage to an OS file system driver 24, which in turn generates transaction 10.

Instead of sending transaction 10 directly to target 30, the transaction may be trapped by a given device, such as a chipset 26 of system 20, which may be executing a virtual machine monitor (VMM) or other such software. Accordingly, the trapped transaction may be provided to a non-volatile storage 27. In various embodiments, storage 27 may be a flash memory such as a NAND-based flash memory. In various embodiments, such storage 27 may be extremely fast storage, e.g., silicon-based storage having speeds of greater than approximately 600 MB/s. Note that after being trapped by chipset 26 transaction 10, rather than being associated with a specific format for a given file system, is instead translated or formatted as a platform-specific transaction. In other words, the generated transaction may be of a different protocol than the OS file system protocol. Transaction 10 may thus be tagged such that it can be trapped by chipset 26 to enable the rapid storage of the transaction into storage 27.

After storage in non-volatile memory 27, which may act as a staging area to stage the data of transaction 10, the transaction may be completed. That is, transaction data from non-volatile storage 27 may be provided to a given target, such as a local target 28 and/or a remote target 30 using a so-called flush mechanism in which the transaction record is written to the target and then deleted from non-volatile storage 27 after confirmation of successful completion of the write operation. Accordingly by using such an embodiment, if transaction 10 is interrupted, e.g., by a failure, power interruption or so forth, the transaction can recover from staging in non-volatile storage 27 and be successfully completed without loss of data.

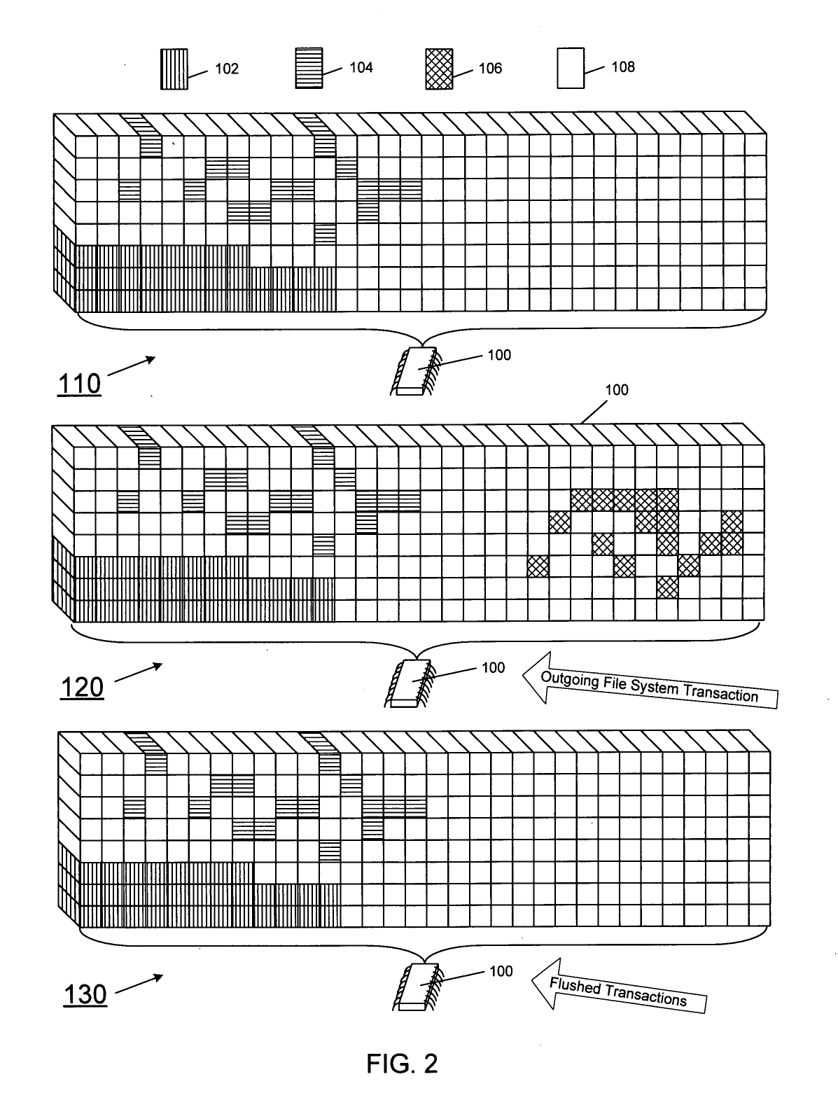

Referring now to FIG. 2, shown is a structure of a non-volatile storage in accordance with an embodiment of the present invention. As shown in FIG. 2, a non-volatile memory 100 may store different types of data in different locations (e.g., different blocks or sectors of data). Specifically, in the legend of FIG. 2, firmware components 102 may be stored in certain memory locations. Such firmware components may include basic input/output system (BIOS) logic, microcode patches and so forth. Furthermore, storage 100 may store firmware data 104, such as platform settings, drivers and so forth. Additionally, transaction data 106 may be present. Such transaction data may correspond to pending file system transactions such as staged transactions stored in accordance with an embodiment of the present invention. Of course, additional free space 108 may be present within storage 100.

As shown in FIG. 2, different information is stored in storage 100 at three different time instances, 110, 120 and 130. Specifically, at time instant 110, firmware components 102 and firmware data 104 is present. At a later time period 120, i.e., after trapping of an outgoing file system transaction in accordance with an embodiment of the present invention, storage 100 further includes transaction data 106, which may correspond to pending file system transactions, which may be in a block-based format. Then at a yet later time 130, i.e., after the pending file system transactions have been flushed after successful completion of the transactions to the target storage, the contents of storage 100 may correspond again to that at first time 110, i.e., with no transaction data present in the storage. While shown with these particular information stores at different times, understand the scope of the present invention is not limited in this regard.

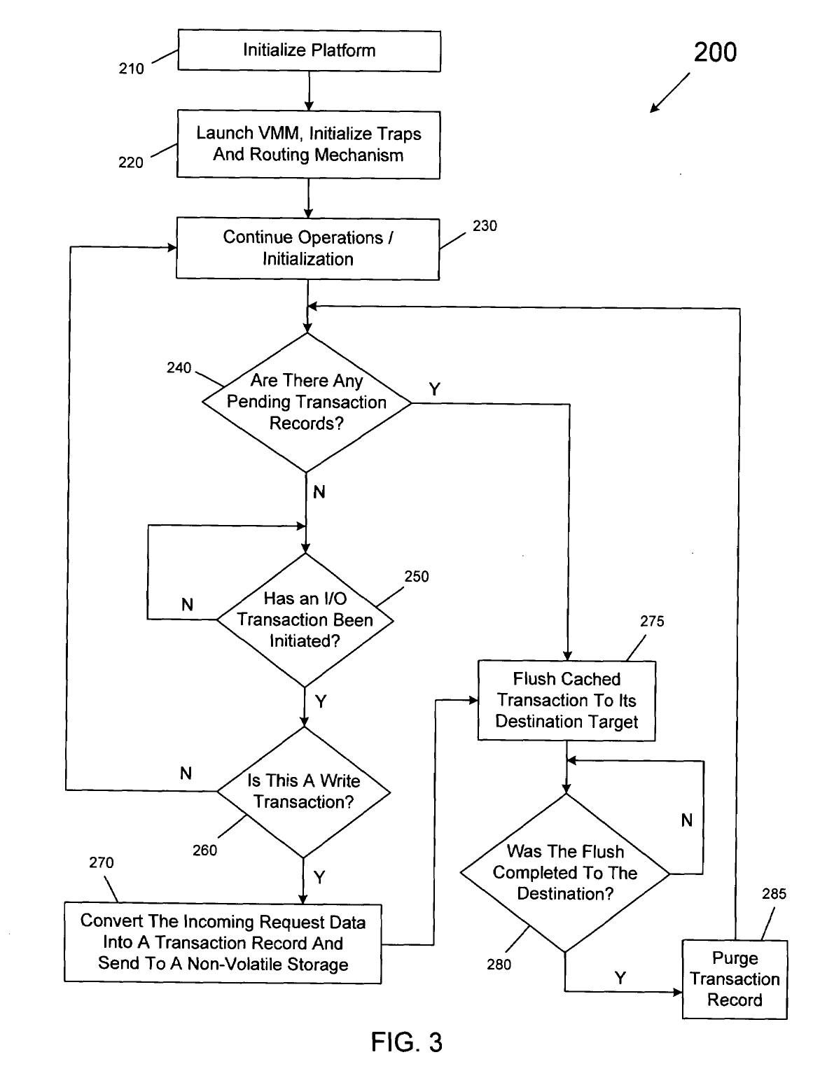

Referring now to FIG. 3, shown is a flow diagram of a method in accordance with one embodiment of the present invention. As shown in FIG. 3, method 200 may be used to perform platform-specific file system transactions in accordance with an embodiment of the present invention. More specifically, as shown in FIG. 3, method 200 may begin by initializing a platform (block 210). Such platform initialization may occur upon startup of a system in which various self-testing, loading of BIOS, and booting of an OS may occur.

Referring still to FIG. 3, after such platform initialization, a VMM may be launched, traps initialized, and a routing mechanism initialized (block 220). For example, a VMM may be launched. Code of the VMM or a virtual machine (VM) executing thereon may include initialization code to initialize traps to enable trapping of file system transactions from a given source to a desired target to be trapped and instead routed via the initialized routing mechanisms to another location. For example, trapped data may instead be routed to a non-volatile storage, e.g., a fast flash. After such initialization and setting up of traps, which may be implemented in a chipset component such as input/output controller hub (ICH) although the scope of the present invention is not limited in this regard, control may pass to block 230, where various system operations may occur/continue and any further system initialization may be performed.

Referring still to FIG. 3, it may then be determined whether there are any pending transaction records (diamond 240). For example, after complete system initialization it may be determined whether any pending transaction records exist in a given non-volatile storage, e.g., the fast flash. If so, this is an indication that one or more transactions from a previous booting of the computer did not successfully complete, e.g., due to a power interruption or other such failure. Accordingly, control passes to block 275, where one or more cached transactions may be flushed to a destination target. While the scope of the present invention is not limited in this regard, such destination targets may correspond to local or remote mass storage devices such as disk drives or other magnetic media.

Note that if no such transactions are determined to be present in the non-volatile memory at diamond 240, control passes to diamond 250, where it may be determined whether an I/O transaction has been initiated. If so, control passes to diamond 260 where it may be determined whether such transaction is a write transaction. If not, control passes to block 230 discussed above. If it is determined that the transaction is a write, control passes to block 270. At block 270, the incoming request data may be converted into a transaction record and sent to the given non-volatile storage. In various embodiments, the incoming request may thus be modified by platform-specific operations, namely the trapping of the data, e.g., in a chipset component and forwarding to form a transaction record in the non-volatile storage. From block 270, control passes to block 275 discussed above.

Referring still to FIG. 3, at diamond 280 it may be determined whether the flush was successfully completed to the destination. If not, control may loop back to block 275 to replay the transaction until it is successfully completed. When the transaction successfully completes, control passes to block 285 where the transaction record is purged, i.e., the data and the non-volatile storage is erased and all metadata associated with the transaction record is similarly removed. Finally, as shown in FIG. 3, block 280 may revert back to diamond 240 discussed above. While shown with this particular implementation in the embodiment of FIG. 3, the scope of the present invention is not limited in this regard.

Referring to Table 1 below, shown is psuedocode for initiating a trap and routing mechanism in accordance with one embodiment of the present invention.

TABLE 1

| | |
|---|---|
| typedef struct { | |
| UINT64 | DevicePathActive:1; |
| UINT64 | FlashContainsMemory:1; |
| UINT64 | MemoryFragments:8; |
| . . . | |
| } INIT_MASK; | |
| typedef struct [ | |
| UINT32 | Type; |
| UINT32 | Pad; |
| EFI_PHYSICAL_ADDRESS | PhysicalStart; // LBA or Memory based on Type |
| UINT64 | NumberOfPages; // If LBA ==# of sectors |
| UINT64 | Bank; |
| } RESOURCE_DESCRIPTOR; | |
| typedef struct { | |
| INIT_MASK | InitMask; |
| //DEVICE_PATH | DevicePath; |
| //UINT32 | DescriptorCount; |
| //RESOURCE_DESCRIPTOR | ResourceDescriptor [DescriptorCount]; |

} EFI_TRANSACTION_DESCRIPTOR;

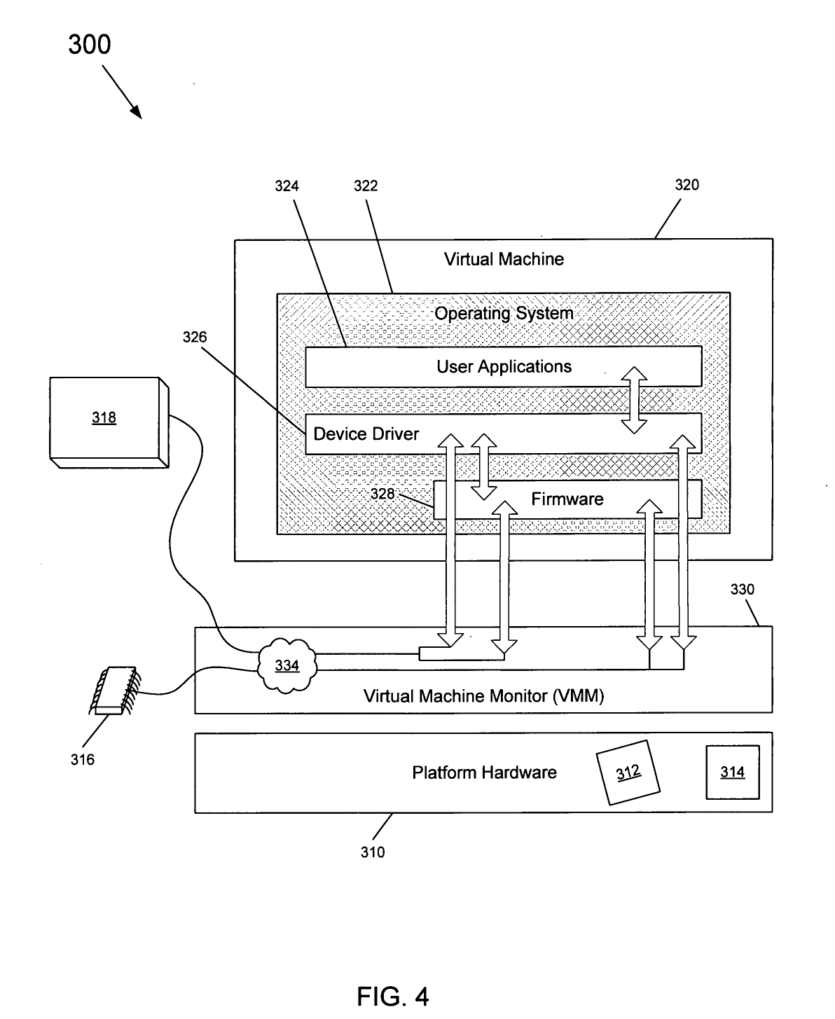

Embodiments may be used in many different platform types. Referring now to FIG. 4, shown is a block diagram of a system in accordance with one embodiment of the present invention. As shown in FIG. 4, system 300 includes various platform hardware 310. Shown for example in the embodiment of FIG. 4 is a processor 312, such as a central processing unit (CPU) and a chipset component 314, e.g., a memory controller, ICH, or other such component. In addition, a non-volatile storage 316 and a mass storage 318 may also be present.

FIG. 4 further shows a VMM 330, which may include a routing agent 334 to control trapping and routing of BIOS system transactions to and from non-volatile storage 316 (and target storage 318). One or more VMs 320 may execute on VMM 330. In the embodiment of FIG. 4, VM 320 includes a guest OS 322 on which various user applications 324 may be executed. In the context of running such applications, a request for storage of data may be issued. Such requests may be provided to a device driver 326. The device driver may run in a privileged level and may correspond to one of a number of such drivers, e.g., video drivers, network drivers, disk drivers and so forth. In turn, driver 326 interacts with firmware 328 which may then pass the transaction through VMM 330, which in turn traps the transaction with routing agent 334 and forwards the data (which is destined for target 318) to non-volatile storage 316.

Then at a later time, such as described above with regard to FIG. 3 the data may be flushed to target 318 and the corresponding transaction record purged from non-volatile storage 316. In this way, data trapping can occur to enable the routing of data such that block-based transactions can be converted to replayable transactions. In some embodiments to enable such trapping, various control registers may be set accordingly. For example, in some implementations an Advanced Power Management (APM) trapping control (ATC) register of a chipset such as an ICH may be set to enable such trapping.

Embodiments thus provide a generic mechanism for enhancing I/O throughput regardless of the target storage, as well as enabling platform-specific transactional processing of I/O throughput so that a platform can gain the benefits of this operation regardless of underlying controller support. Still further, the benefits of transaction file system behavior (replay, complete partial writes, etc.) may be realized without having to have specific knowledge of the target format or having a specific underlying format presumption. In fact, the transaction need not be specific to a local device, as it could also be directed to remote components, even such components having different file system capabilities.

Still further, these cached events can be converted into transactions (similar to a transactional file system) except that the format is platform-specific and based on the logical block address (LBA) of the source/target. This enables replay of failed transactions or the continuation of transactions when a system might crash during the write process.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
trapping a write request in a chipset component, the write request directed from an application to a target storage and corresponding to an outgoing file system transaction including data to be written to the target storage;
converting the write request to a transaction record and forwarding the transaction record to a non-volatile storage, the transaction record including the data and corresponding to a platform-specific transaction having a different protocol than the outgoing file system transaction; and
storing the transaction record in the non-volatile storage and thereafter forwarding the transaction record from the non-volatile storage to the target storage.

2. The method of claim 1, further comprising purging the transaction record from the non-volatile storage if it is determined that the transaction record was successfully stored in the target storage.

3. The method of claim 1, further comprising trapping the write request using a virtual machine monitor (VMM) to trap the data.

4. The method of claim 1, further comprising determining whether any transaction records are present in the non-volatile storage upon initialization of a system including the non-volatile storage and flushing the transaction records, if present.

5. The method of claim 4, wherein flushing the transaction records comprising writing the transaction records to the target storage and deleting the transaction records from the non-volatile storage after confirming successful writing to the target storage.

6. The method of claim 1, wherein the non-volatile storage is a flash memory of a first system including the chipset component and the second storage is a mass storage device of a second system remotely coupled to the first system.

7. The method of claim 1, wherein the outgoing file system transaction corresponds to an operating system (OS) file system transaction having a first protocol, the first protocol platform independent and OS-specific, and the transaction record has a second protocol corresponding to a platform-specific and OS-independent protocol.

8. The method of claim 2, further comprising replaying the transaction record from the non-volatile storage to the target storage if it is determined that the transaction record was not successfully stored in the target storage.

9. An article comprising a machine-accessible medium including instructions that when executed cause a system to:
trap a write request directed from an application to a target storage, the write request corresponding to an operating system (OS) file system transaction including data to be written to the target storage, wherein the data is block-based;
convert the write request to a platform-specific file system transaction and forward the platform-specific file system transaction to a non-volatile storage; and
store the platform-specific file system transaction in the non-volatile storage and thereafter forward the platform-specific file system transaction from the non-volatile storage to the target storage.

10. The article of claim 9, further comprising instructions that when executed enable the system to determine whether any platform-specific file system transactions are present in the non-volatile storage upon initialization of the system and flush the platform-specific file system transactions, if present.

11. The article of claim 10, further comprising instructions that when executed the system to write the platform-specific file system transactions to the target storage and delete the platform-specific file system transactions from the non-volatile storage after confirmation of successful writing to the target storage.

12. The article of claim 9, wherein the OS file system transaction is platform independent and OS-specific, and the platform-specific file system transaction is OS-independent.

13. A system comprising:
a processor;
a chipset coupled to the processor;
a non-volatile storage coupled to the chipset;
a mass storage coupled to the chipset; and
a dynamic random access memory (DRAM) including instructions to trap a write request directed from an application to a target storage, the write request corresponding to an operating system (OS) file system transaction including data to be written to the target storage, convert the write request to a platform-specific file system transaction and forward the platform-specific file system transaction to the non-volatile storage for storage, and thereafter forward the platform-specific file system transaction from the non-volatile storage to the target storage.

14. The system of claim 13, wherein the chipset is to trap the write request and reformat the OS file system transaction to the platform-specific file system transaction and to forward the platform-specific file system transaction to the non-volatile storage.

15. The system of claim 13, further comprising a virtual machine monitor (VMM) including a routing agent to route the platform-specific file system transaction to the non-volatile storage and to receive and forward the platform-specific file system transaction to the mass storage, wherein the mass storage corresponds to the target storage.
